(19) United States
(12) Patent Application Publication
(10) Pub. No.: US 2013/0332262 A1
(43) Pub. Date: Dec. 12, 2013

(54) Internet marketing-advertising reporting (iMar) system

(71) Applicants: John Hunt, Santa Clarita, CA (US); William Conrad, San Diego, CA (US)

(72) Inventors: John Hunt, Santa Clarita, CA (US); William Conrad, San Diego, CA (US)

(21) Appl. No.: 13/507,371

(22) Filed: Jun. 11, 2012

(51) Int. Cl. G06Q 30/02

(52) U.S. Cl. 705/14.43; 705/14.54

(57) ABSTRACT

A contextual advertising system depends on embedded decision-influence algorithms to parse the keywords in web-user searches to identify the public search-engine networks best able to respond with the most relevant advertisement results. Marketing managers control which kind of advertisements get automatically selected by planting product/service, price, place and promotion (4P) keywords which correlate to each of the four traditional Marketing Mix categories. Language-independent, proximity pattern matching algorithms are used to increase matching accuracy and customer click-through-rates (CTR) and their ultimate purchase decisions. Each 4P Marketing Mix contextual smart-advertisement can be independently displayed in full, or linked to an existing online advertisement to enhance match accuracy and the CTR.

### RELATED APPLICATIONS

This application claims benefit of U.S. Provisional Patent Application Ser. No. 61/494,133, filed Jun. 7, 2011, and titled INTERNET MARKETING-ADVERTISING REPORTING (iMAR). Such is incorporated herein by reference in its entirety.

### FIELD OF THE INVENTION

The present invention is directed to Internet Contextual advertising Systems, and more particularly to an Internet Marketing-advertising Reporter (iMAR) system and search engine network that selects and displays a product and/or service 4P Marketing Mix contextual smart-advertisement, on a web-user-search Search-Result-Page (SRP)/Web Content and site-visitor Viewer-Page that is generated from the product and service owner or provider of advertisements included within posted and or published websites with regard to additional information.

### BACKGROUND

Contextual advertising selects the advertisements that appear on websites and elsewhere according to predefined targets. The advertisements are chosen according to their content and dished up by automated systems to be displayed to users who would find them relevant somehow.

Some contextual advertising systems scan websites for keywords and return particular advertisements back to the webpage based on those keywords. Other contextual advertising systems base their responses on the users' queries. For example, if a web-user is viewing a website about new cars and that website uses contextual advertising, that particular web-user may be targeted to see advertisements for local dealers, reviews, and auto financing. If the targeted advertisement isn't clicked on soon enough, the advertisement may be automatically changed to a next relevant advertisement with a go-back button to the previous advertisement.

Google adSense was one of the first major contextual advertising networks, it displays relevant advertisements from the Google inventory of advertisers. Webmasters are given a JavaScript code to insert into their own webpages. A relevance score is calculated by a separate Google bot, Mediabot, that indexes the content of a webpage. More sophisticated systems use language-independent proximity pattern matching algorithms to increase matching accuracy.

Website earnings have increased substantially thanks to contextual advertising. advertisements are more targeted, so they are more likely to be clicked, thus generating revenue for everyone involved. The largest part of Google's corporate earnings comes from its adSense program.

In third-party hyperlinking, a third-party installs software onto a web-user's computer that interacts with the web browser. Keywords in webpages are displayed as hyperlinks that jump to advertisers.

What is needed are more effective ways to deliver on the promises of contextual advertising.

### SUMMARY OF THE INVENTION

Briefly, embodiments of the present invention provide context advertising to drive and improve click-through-rates and purchase results. A search engine is typically provided to a web-user over the Internet that allows the web-user to enter keywords and conduct searches. A results page has space available alongside the lists of results that can be appropriated to display advertisements. Which advertisements to display are selected according to information on hand about the users, their location, search histories, or anything else that can help limit the advertisements displayed to ones this web-user would find interesting and useful. Such information is derived from the search terms entered by the users.

Once having read through the present disclosure and having studied the accompanying illustratations, artisans will no doubt come to understand the many variations and alternatives that are made possible. These derivatives are, however, a part of the scope and breadth of the subject matter being claimed herein.

### BRIEF DESCRIPTION OF THE FIGURES

The foregoing and other objects, features and advantages of the invention will be apparent from the following more particular description of preferred embodiments of the invention, as illustrated in the accompanying drawings in which like reference characters refer to the same parts throughout different views. Others will be readily apparent to those skilled in the art.

FIG. 1A number of steps of System of the present invention;

FIG. 2 Search-Result-Page (SRP/Web Content advertisement page to the present invention;

FIG. 3 Search-Result-Page (SRP)/Web Content Sponsored advertisement and Product/service 4P Marketing Mix contextual smart-advertisement (Sponsored advertisement)

FIG. 4 Web-user search result page that has been scanned with a media bot and the data was used to generate 4P Marketing Mix contextual smart-advertisement (Web Content Sponsored advertisement) and a 4P Marketing Mix Banner (Web Content Sponsored advertisement);

FIG. 5 Web-user-Search Search result Page (SRP)/Web content Sponsored advertisement;

FIG. 6 Site-Visitor Viewer/Page Sponsored advertisement;

FIG. 7 iMAR System Module Step Diagram;

FIG. 8 iMAR System Module Logic Flow Diagram;

FIG. 9 iMAR System Module Keyword-Multi-Words;

FIG. 10 Computer Step Diagram;

FIG. 11 advertisement Reporter advertisement Algorithm; and

FIG. 12 advertisement Reporter Banner Algorithm.

### DETAILED DESCRIPTION OF THE PREFERRED EMBODIMENTS

Contextual advertising is a new alternative to traditional online advertising made possible by the Internet. The content of advertisements served up on a web-user search can be directly correlated to the webpages then being viewed, e.g., on a Search-Result-Page (SRP) or site-visitor Viewer-Page. Contextual advertising entices viewers by providing product and service information relevant to them, and the successes can be measured in Click-Through-Rates (CTR) and purchases.

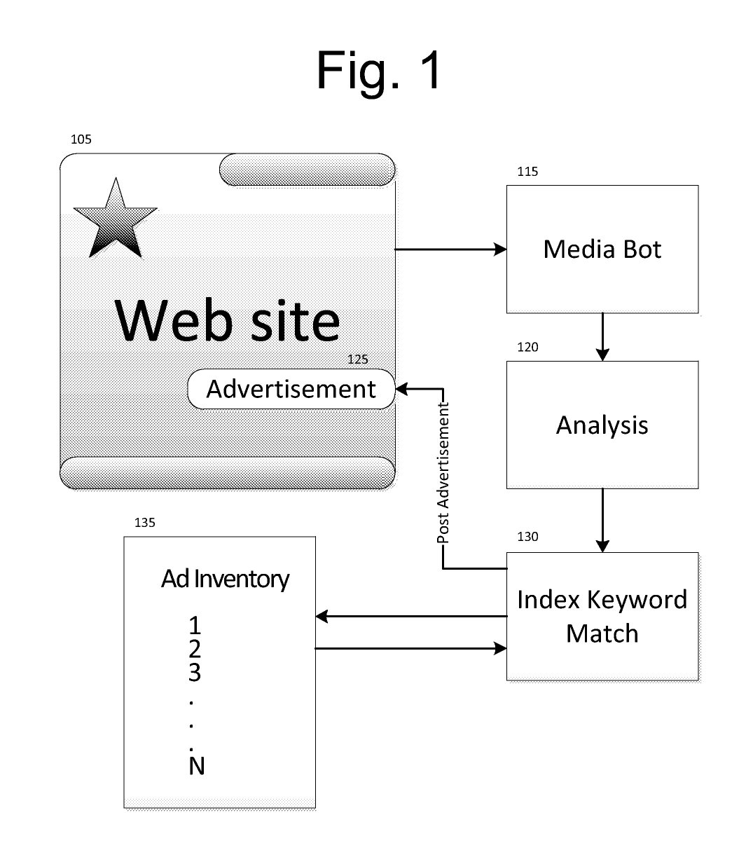

Referring now to FIG. 1, Yahoo! Publisher, Google advertisement Word, Microsoft adCenter, advertising.com, and others provide support for a contextual advertising network. They provide webmasters with JavaScript code that can be easily inserted into webpages (105) that will display relevant advertisements from the contextual advertising service providers inventory of advertisers. A relevance score is calculated by a separate automated computer Internet data search or Media Bot (115) that indexes the content of a webpage. This data is analyzed for content (120). The analyzed content is compared to relevant advertisements stored in a database. After an analysis and comparison (130) to a database (135), the best advertisement (125) is then displayed on the users web page (105).

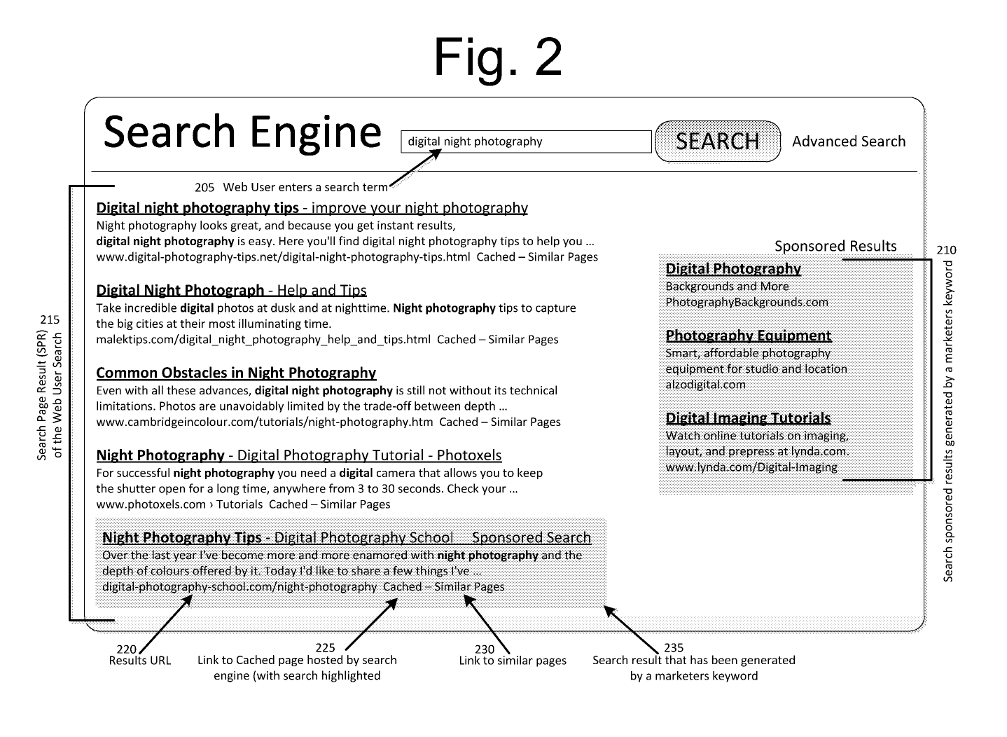

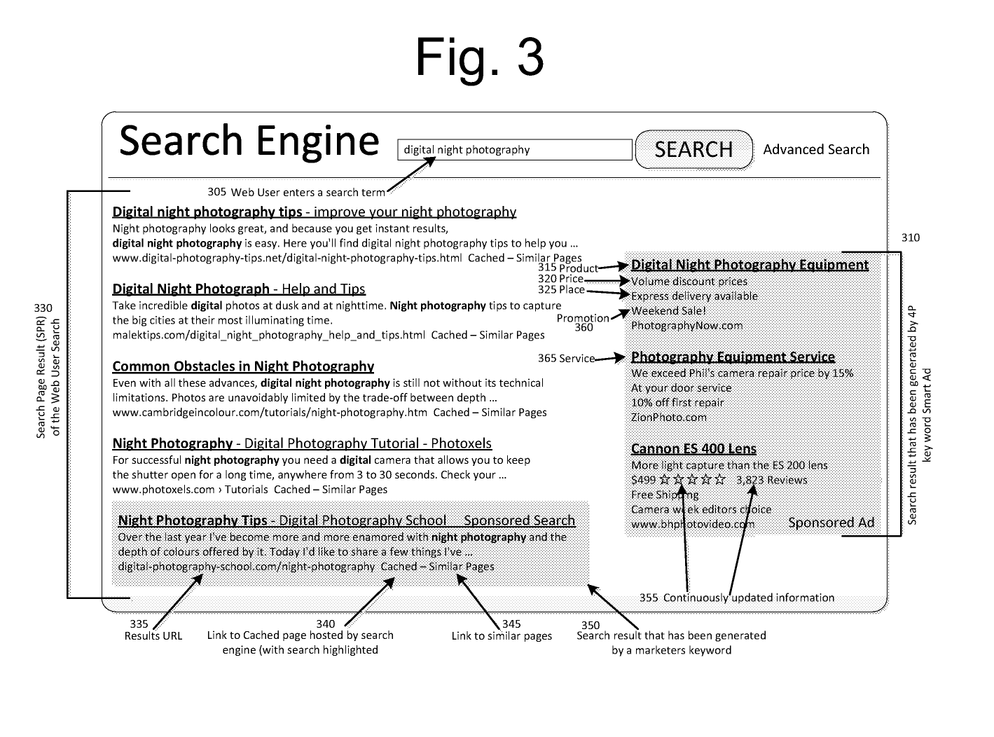

In FIGS. 2 and 3, a Web-user-Search Search Result Page (SRP)/Web Content routine, the advertisement displayed is based on web-web-user keyword search query that is entered into a search engine (205) (305) and a web-web-user search results page is displayed (215) (330). Part of the display is the actual URL or web address of the search (220) (335). Also available is a local copy of the web page (225) (340) and a link to do an additional search biased on the previous search (230) (345). The Web Content sponsored advertisement (210) is selected and displayed by an automated contextual advertising network(s) that determines advertisement content. The search results advertisements generated by marketing mangers' keyword query is typically displayed on the left hand side of the page (235) (350), as shown in FIG. 2.

In a site-visitor Viewer-Page routine, the contextual advertising system scans the text of a website for keywords and returns advertisement to webpage based on what the web-web-user is viewing. The advertisement displayed is based on the web site-visitor Viewer-Page. Similar to the web-user-search Search-Result-Page (SRP) routine, the web content sponsored advertisement is displayed on page, except in the form of a popup, rollover, banner/display, etc. For example, if a web-web-user is visiting an air travel website and an advertisement appears on their page offering a special airfare price. Whether an advertisement is presented as a pop-up, rollover, display/banner, etc., this is referred to as contextual advertising. What makes the advertisement contextual is that the subject matter in the advertisement is relevant to the web site continence. Apart from that when a visitor doesn't click on the advertisement in a go through time (minimum) (unless a web-web-user clicks on the advertisement) the advertisement is automatically changed to next relevant advertisement showing the option of going back to the previous advertisement.

Google® advertisement Words® allow marketers to purchase keywords so when a web-web-user types in selected keywords into a search engine, an advertisement based on the paid keywords will be posted prominently alongside the search results. For example, an advertiser may buy the keyword “cold weather” for the sale of textiles. When a web-web-user of a search engine types in “cold weather”, the web-web-user may receive search engine results for climate or perhaps the local forecast, and also may receive an advertisement for the sale of textiles. Some other parameters may include geographic data. Marketers can choose to only display advertisements in Mountain View, Calif. and nowhere else. They may also input negative keywords. For example, do not list advertisement results for weatherman. Such can be limiting, as many additional details of the purchasing and selling experienced are not expressed. The results of these constraints are non-effective advertisements that waste advertising space and result in low Click-Through Rates (CTR).

There is a need in the art for improved advertisement (advertisement) match accuracy listings that would promote more Click-Through-Rate (CTR) on a web-user-search Search-Result-Page (SRP)/Web Content and site-visitor Viewer-Page.

The 4P's of advertising are product/service, price, place and promotion. Conveying a product or service using a 4P Marketing Mix components improves Click-Through Rates on banner advertisements search engine sponsored advertisements, and advertisements in web site pages. When coupled with highly-relevant marketing principles keyword/Multi-Words in advertisement this would significantly enhance advertisement effectiveness, and contextual advertising network ability to more accurately match advertisement on a web-user-search Search-Result-Page (SRP) and site-visitor Viewer-Page webpage.

There is a need in the art for a smart advertisement that would satisfy the potential buyers most relevant pre-purchase questions. And for a product and/or service smart advertisement with embedded 4P Marketing Mix keyword/multi-words and language-independent proximity pattern matching algorithm to increase matching accuracy and capability to improve advertisement Click-Through-Rate (CTR) on a web-user-search Search-Result-Page (SRP)/Web Content and site-visitor Viewer-Page. A new 4P Marketing Mix contextual smart-advertisement (310) can be displayed in the same search engine as a sponsored advertisement display. In addition the product (315) and service (365) changing information such as availability would be linked and displayed in real time (355). A typical web-user result is as shown in FIG. 3.

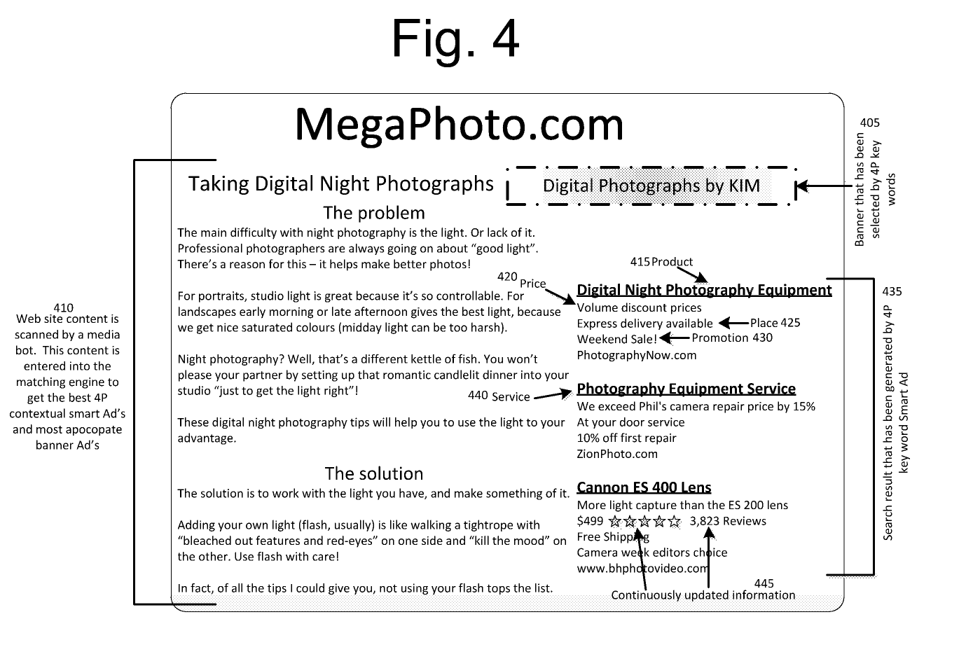

FIG. 4 represents a web page that was the result of a search engine click through. The 4P contextual smart advertisements were generated by analyzing the content of the page (410). The 4P marketing mix contextual smart advertisement generated (435) would have relevant product (415) service (440) information with a price (420) place (425) and promotion (430) components. In addition the product (415) and service (440) changing information such as availability would be linked and displayed in real time (445). The banner advertisement (405) is selected and display by using 4P keywords.

According to a first aspect of the present invention includes providing a system of applications that interface to search engine API's. The data that needs to be passed includes the search string, if available, cookie data and recent browsing history, if the web-user has been using the search engine long enough to have history. If the actual search page or web page contains relevant information this is sent along as well. Once this data is received, the data is analyzed by an advertisement matching engine. This compares the data sent by the search engine API and the web users previous visit/search history to a database of 4P advertisements. The results are passed to an advertisement generator that makes a custom advertisement that is specific to all the relevant parameters. This targeted advertisement is a 4P Marketing Mix contextual smart-advertisement on a web-user-search Search-Result-Page (SRP)/Web Content and site-visitor Viewer-Page.

A 4P Marketing Mix contextual smart-advertisement is embedded with 4P Marketing Mix Keyword/Multi-Words and language-independent proximity pattern matching algorithm to increase matching accuracy and improve the customer Click-Through-Rate (CTR) and purchase decision. 4P Marketing Mix contextual smart-advertisement content is constructed with 4P Marketing Mix Keyword/Multi-Words: product/service, price, place and promotion components, a product and a service description, a price of an item, a place to purchase the product or service, and a promotion; and the data is used to select and serve a specific advertisement. This includes communicating the specific sponsored advertisement for display on a web-user-search Search-Result-Pages (SRP)/Web Content and or site-visitor Viewer-Page from the product and service owner or provider of advertisements included within posted and or published websites.

Another embodiment of the present invention includes monitoring a plurality of Internet search engines, selecting search engine network based on the product or service 4P Marketing Mix contextual smart-advertisement keyword/Multi-Words content that is interpreted by embedded decision-influence routines that algorithmically selects the optimum Internet advertisers (IA) Yahoo!, Google, Microsoft, etc. search engine network with most relevant web-user-search Search Result Page (SRP)/Web Content sponsored advertisement match functionality and Internet advertisers contextual advertising network, e.g., Yahoo! Publisher, Google advertisement Word, Microsoft adCenter, advertisement Reporter, etc. with most relevant site-visitor Viewer Page sponsored advertisement match functionality and computational accuracy to discreetly deliver a 4P Marketing Mix contextual smart-advertisement. Method includes using the search string, cookie data, recent browsing history and additional relevant web page information to select and generate a specific 4P sponsored advertisement. From marketing mangers' prospective, the 4P they used in a specific advertisement is specifically matched to the best Internet search engine and contextual advertising network to communicate the specific sponsored advertisement for display.

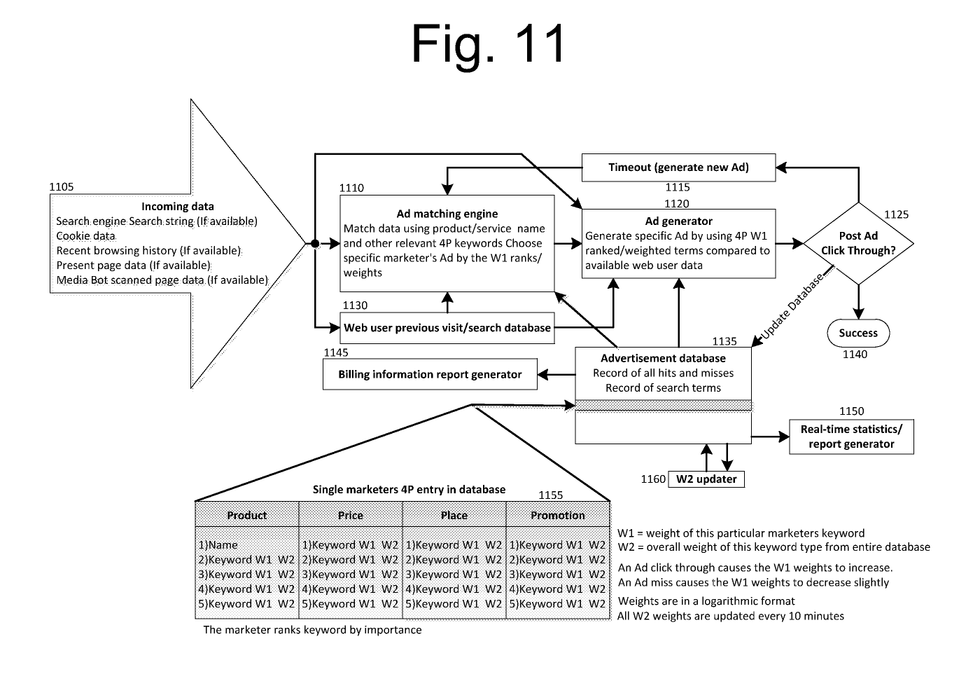

A further embodiment of the present invention includes an advertisement Control to measure, optimize, balance and refine online advertisement. The advertisement Control provides capability to improve advertisement performance by modifying one or more product and/or service 4P Marketing Mix contextual smart-advertisement keyword/multi-words (content) at System module Web-user Interface component. This is explained in detail in the advertisement reporter advertising algorithm FIG. 11.

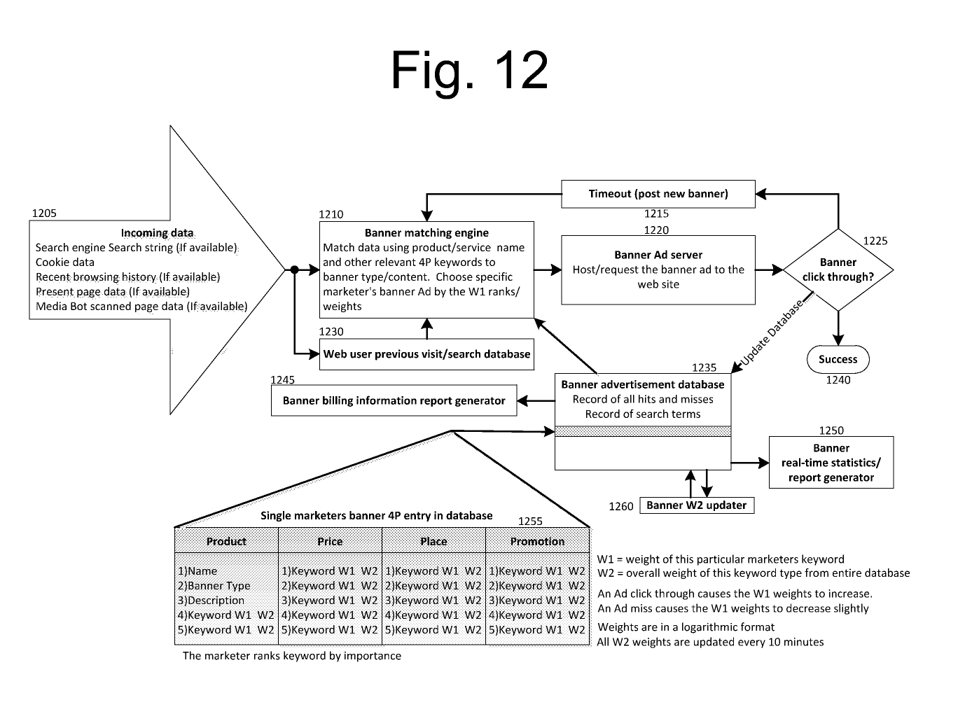

In another embodiment of the present invention, there is provided a method providing a system of applications that use a media bot to scan the web-user site and deliver a 4P banner advertisement. The media bot would first scan the web page, analyze the data for content, combine it with the individual web users historical data, if present then match the content to marketing mangers' optimal 4P advertisement. Each banner has a specific set of 4P (product/service, price, place and promotion) components describing the banner content. From this the algorithm selects the optimal banner for the web page. This is explained in detail in the advertisement reporter banner algorithm FIG. 12.

In another embodiment of the present invention, there is provided a method providing a system of applications that interface the advertisement database and banner advertisement database to marketing mangers' web site API. This provides the ability for marketing mangers to only have to update the information on one web site instead of two. In addition there is a media bot that is able to scan marketing mangers' web page to update certain parameters in the advertisement database and banner advertisement database from marketing mangers' web page. Typically these parameters are subject to frequent change. For example, the amount of inventory available of an item would change as the items are purchased. This set of applications continuously keeps marketing mangers' current information in agreement with the advertisement being generated and the banners being served. In this way, the web-user does not view out of date advertisement promotions.

The scanned information from a media bot could also be used to generate 4P keywords directly, such as to automate the process of entering in many products/services that a large web site would have.

In another embodiment of the present invention, the database is continuously analyzed to improve Click-Through-Rate (CTR) and purchase decisions. A service task combs through all the searches, other relevant information in the advertisement database, or the banner advertisement database, along with input from the reporter staff input to adjust the overall weights that are applied to each of marketing mangers' 4P keywords. Weights and scores are represented in logarithmic format. This method gives proportionally higher reward to successful advertising campaigns. It also slowly reduces a less successful advertising campaign. This is done by having a non-linear log scale that places a high value on click through success.

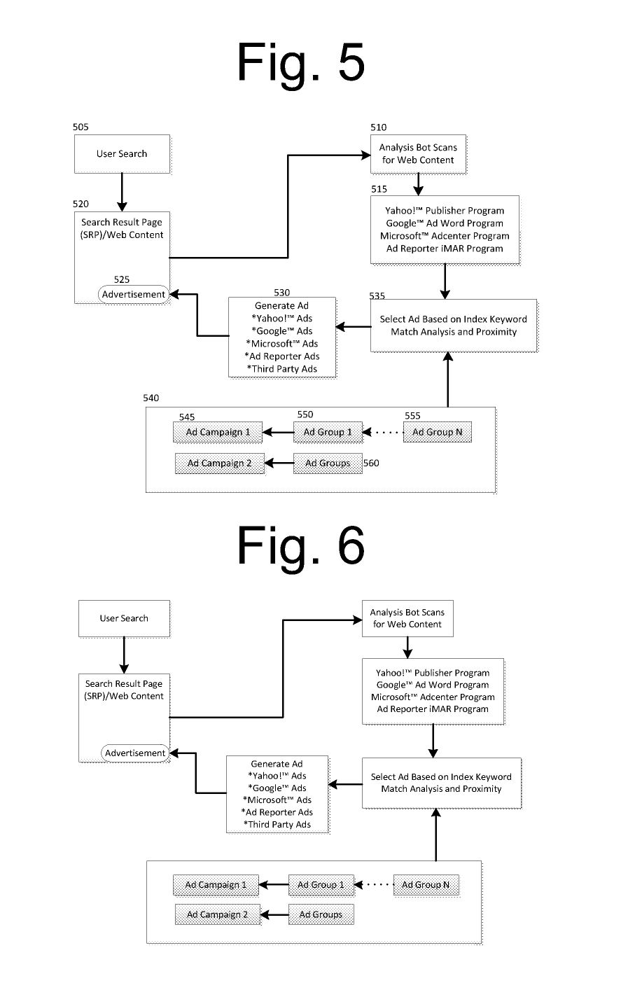

The Internet Marketing-advertising Reporter (iMAR) is a web-user-centered contextual advertising system module networked to a search engine network that selects and displays a sponsored 4P Marketing Mix contextual smart-advertisement on a web-user-search Search-Result-Pages (SRP)/Web Content FIG. 5 and site-visitor Viewer-Page FIG. 6 that is generated from marketing mangers' product/service or provider of advertisements included within posted and or published websites. iMAR system module provides marketing mangers with decision-influence functionality and capability to develop a product/service 4P Marketing Mix contextual smart-advertisement, embedded with 4P Marketing Mix: (product/service, price, place and promotion) components and marketing principle Keyword/Multi-Words with language-independent proximity pattern matching algorithm to increase matching accuracy and improve the customer Click-Through-Rate (CTR) and purchase. The product and service 4P Marketing Mix contextual smart-advertisement content is constructed by marketing mangers selection of defined 4P Marketing Mix keyword/multi-words correlating to each of the 4P Marketing Mix components categories. The product and service advertisement 4P Marketing Mix keyword/multi-words are interpreted by embedded decision-influence routines that algorithmically selects the optimum Internet advertisers (IA) Yahoo!, Google, Microsoft, etc. search engine network with most relevant web-user-search Search-Result-Page (SRP)/Web Content sponsored advertisement match functionality and Internet advertisers contextual advertising network, e.g., Yahoo! Publisher, Google adWord, Microsoft adCenter, advertisement Reporter, etc. with most relevant site-visitor Viewer-Page sponsored advertisement match functionality and computational accuracy to discreetly deliver 4P Marketing Mix contextual smart-advertisement. The 4P Marketing Mix contextual smart-advertisement would be displayed independently and or linked to an existing online advertisement to enhance match accuracy and Click-Through-Rate (CTR). advertising network, e.g., Yahoo! Publisher, Google advertisement Word, Microsoft adCenter, advertisement Reporter, etc. with the most relevant site-visitor Viewer-Page sponsored advertisement shown in FIG. 6 match functionality and computational accuracy to discreetly deliver 4P Marketing Mix contextual smart-advertisement. The iMAR Systems 4P Marketing Mix contextual smart-advertisement would be served and displayed independently and or linked to a contextual advertising network to enhance existing advertisement match accuracy and Click-Through-Rate (CTR).

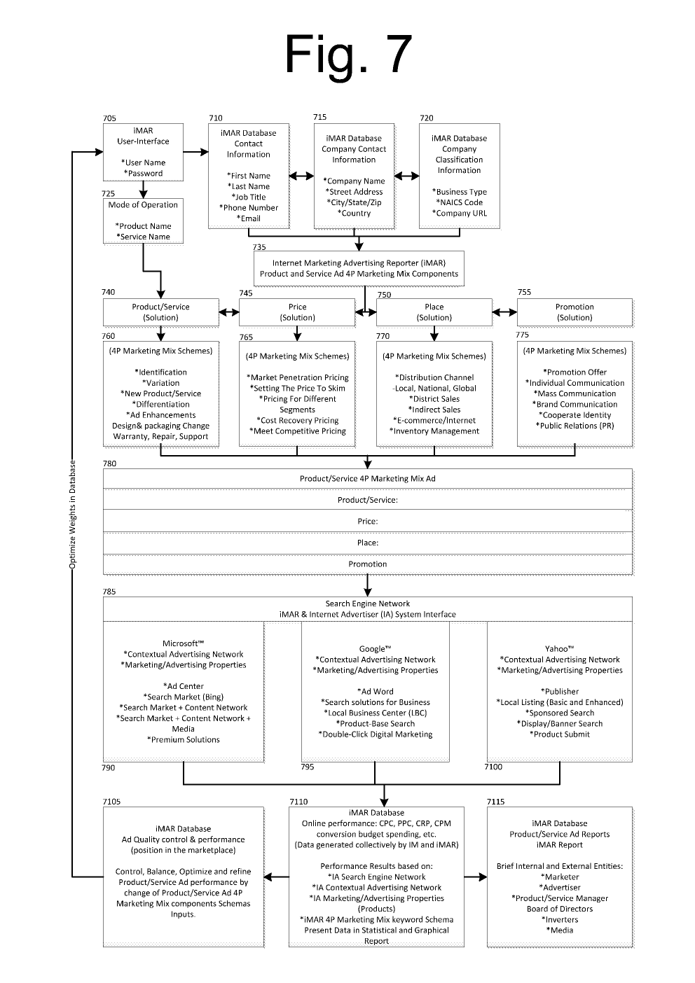

Turning now to FIG. 7, a method 700 begins a system that includes functional parts. The parts can be software or hardware with various possible configurations within the scope of the present invention. System 700 includes a web-user interface 705, and first through third databases 710, 715, 720 for particular data. The web-user interface 705 provides a web-user name and password and provides marketing mangers' access to System 700. System 700 includes a first database 710 that contact information to identify a marketers including a marketers first name, last name, and contact information via phone, email, or social network screen name. This may include the users IP number as well. System 700 also includes a second database 715 that includes company information. Such data may include company name, address, state, country and zip code information. System 700 also includes a third database 720, which is a storage medium that includes business classification information. For example, the business can be a product or service provider and relevant information to classify the business in a particular logical schema for System to group relevant data.

The web-user interface 705 communicates with the first through third databases 710, 715, 720 and also communicates with the mode of operation 725 that specifies a product name and service name. The first through third databases 710, 715, 720 also communicates with an iMAR System module 735. System 700 also includes 4P Marketing Mix steps that are a Product, service step 740, a Price step 745, a Place step 750, and a Promotion step 755.

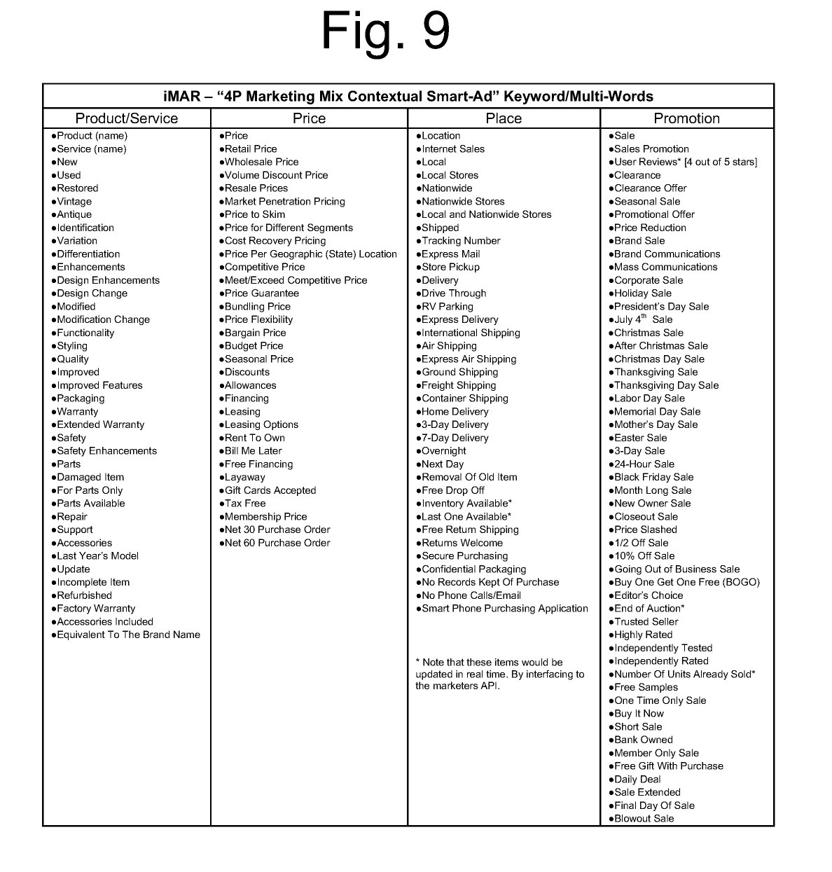

System 700 includes 4P Marketing Mix Keyword/Multi-Words schemas that assist with the composition of an advertisement according to the present invention. System 700 includes a 4P Marketing Mix step 760. The step 760 includes the Product or service identification and differentiation schema, and correlating 4P Marketing Mix Keyword/Multi-Words FIG. 9. The step 760 is connected to the Product and service step 740. System 700 also includes a 4P Marketing Mix step 765 that includes the product and/or service Price 4P Marketing Mix Keyword/Multi-Words FIG. 9. An example price keyword that a marketing manager might use would be Bargain Price. System 700 also includes a 4P Marketing Mix step 770 connected to step 750 that includes a place or location to purchase the product and/or service. An example of a product and/or service would be helmet mounted Video camera or auto detailing respectfully. An example that a marketing manager might use of a place keyword would be Internet or Mountain View, Calif. System 700 also includes a 4P Marketing Mix step 775 connected to step 755. The step 775 preferably includes a product and/or service Promotion 4P Marketing Mix Keyword/Multi-Words FIG. 9. For example a marketing manager might use a promotion of 10% off for a step 775 keyword. The 4P Marketing Mix steps 760, 765, 770, 775 are connected to the product/service 4P Marketing Mix advertisement step 780. The 4P Marketing Mix advertisement step 780 uses data from the particular 4P Marketing Mix steps 760, 765, 770, 775 and marketing mangers' and product or service information to develop a 4P Marketing Mix contextual smart-advertisement (advertisement) that includes multiple parameters including product and/or service, price, place, and promotion coupled with 4P Marketing Mix Keyword-Multi-Words to compose an optimal advertisement (advertisement).

The advertisement is networked to an Internet advertisers (IA) search engine network, e.g., Yahoo!, Google, Microsoft, etc. system interface 785. The Internet advertisers (IA) system interface 785 includes an application programming interface (API) that has an algorithm that will provide the advertisement to a web search engine and contextual advertising network 790, 795, 7100, e.g., GOOGLE ADWORDS, MICROSOFT ADVERTISEMENT CENTER, YAHOO! PUBLISHER, etc. for match functionality and display on web-user-search Search-Result-Page (SRP)/Web Content and site-visitor Viewer-Page.

The advertisement (advertisement) performance data regarding the advertisement that is produced by the Internet advertisers (IA) contextual advertising network, including a statistical/graphical/historical analysis of the Cost-Per-Click (CPC), Cost-Per-Mille, (CPM), Pay-Per-Click (PPC), Click-Through-Rate (CTR), etc. is reported to a Product/service advertisement Performance database step 7110 that can provide a measurement of the product or service advertisement performance. System 700 also includes a Product/service advertisement quality control at step 7105 that includes method to measure, optimize, balance and refine the advertisement parameters. The advertisement quality control provides capability to improve advertisement performance by modifying one or more of the 4P Marketing Mix contextual smart-advertisement keyword/multi-words (content) at the Web-user Interface 705. System 700 also includes an iMAR system data base 7115 that includes functionality features to generate highly-relevant 4P Marketing Mix contextual smart-advertisement performance and Return-on-Investment (ROI) advertisement Reports, specifically tailored for internal and external entities, including marketing mangers, advertiser, manager, board of directors, investors, media/public relations, etc. These advertisement reports would have statistical analysis of the data and present this information in a historical and graphical format.

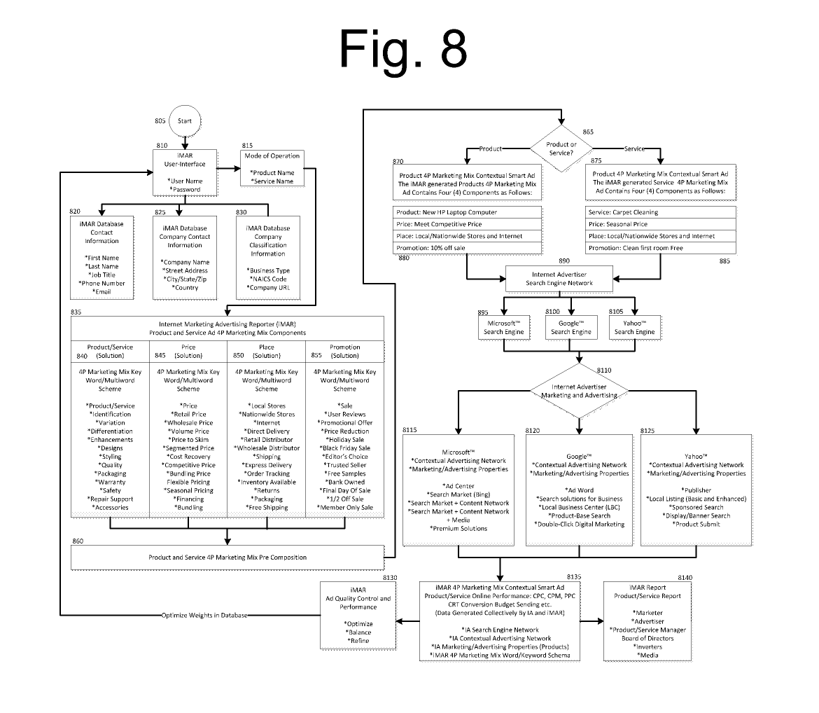

Turning now to FIG. 8, a method 800 begins at step 805 and passes to step 810. Method 800 receives a web-user name and password information at step 810 and a product or service mode of operation at step 815 from different operating modes. In step 820, 825 and 830, parameters of the advertiser are received including contact information at step 820, company identification information at step 825 and company classification identification information at step 830. Method 800 passes to a 4P Product/service Components step 835 where an advertisement 4P Marketing Mix contextual smart-advertisement keyword/multi-words are selected to compose advertisement content. For example, Method 800 may include a product/service parameter, a price parameter, a place parameter and a promotion parameter in step 840, 845, 850 and 855. For example, the advertisement may include 4P Marketing Mix Keyword/Multi-Words relating to a product or service by identification, price, access point and a promotional aspect. For example, the iMAR system module uses the product and service 4P Marketing Mix: Product/service, Price, Place and Promotion components as keyword specific metrics. Each of the 4P marketing mix categories serves its own function as do the highly-relevant marketing principles key multi-words in a given category. The marketing principles keywords correlate with each of the 4P marketing mix components categories. iMAR system module generates product and service 4P marketing mix contextual smart advertisement that are embedded with 4P Marketing Mix (product/service, price, place, and promotion) components and marketing principles keywords with language-independent proximity pattern matching algorithm to increase matching accuracy and improve the customer Click-Through-Rate (CTR) and purchase decision. Some of the Marketing Mix components have values that are changing. One example is the amount of inventory of a specific item. As items are purchased the inventory decreases. A web bot can be set up to scan marketing mangers' web site to check on inventory levels and update the iMAR database. additionally, an interface between marketing mangers' database may be set up through their API and the iMAR database. This would allow many 4P parameters to be altered by the webmaster of the Marketers database as price/shipping/inventory/promotions/etc. and marketing campaigns change.

The iMAR system keywords appear with statistically frequency in contextual advertisements: as such they are tailored in bidding strategy, e.g., impression, Pay-Per-Click (PPC), Cost-Per-Mille (CPM), Cost-Per-Click (CPC), Click-Through-Rate (CTR), etc. by software and by comparing a keyword/Multi-Word specific price-based wordlist. iMAR keywords serve as an informed strategy based on actual search engine network web-user-search Search-Result-Page (SRP)/Web Content and contextual advertising network site-visitor Viewer Page sponsored advertisement match to increase Click-Through-Rate (CTR) and purchase.

Method 800 passes to step 860 where the advertisement 4P Marketing Mix components are networked with product or service selection step 865. Method 800 may pass to step 865 where a decision is reached as to whether the advertisement subject matter includes a product or service at step 865. At step 870, Method 800 includes Product advertisement 870 that are generated with at least four parameters including product, price, place and promotion 880. In another embodiment, Method 800 may pass to step 875 to formulate a service advertisement where data is collected at step 885 including price, place and promotion. Method 800 passes to step 890 where a decision is reached to select an optimal search engine network 890. Method 800 may choose between a first through third search engines 895, 8100 and 8105 for example, GOOGLE™, MICROSOFT™, YAHOO™, etc. or any other search engine known in the art. In step 8110, Method 800 makes a decision to generate advertisement in steps 8115, 8120 and 8125 using Microsoft adCenter™, GOOGLE adWord™, Yahoo! Publisher™, etc. Contextual advertising Network. In step 8130, Method 800 may provide quality control to optimize, balance or refine the advertisement in step 8130, and may provide product or service performance data in step 8135, and a product service advertisement Report in step 8140.

The product and service advertisement performance results, including impressions, Cost-Per-Click (CPC), Pay-Per-Click (PPC), Click-Through-Rate (CTR), Conversions, Budget and Spending Summary, etc. are measured algorithmically by the Internet advertiser (IA), e.g., Microsoft, Google, Yahoo, etc. applications: (1.) search engine network (search-engine) and (2.) contextual advertising network. In additionally, the iMAR system 700 would measure the product and/or service 4P Marketing Mix contextual smart-advertisement performance by algorithm that compares keyword/multiword specific price-based word-list. iMAR would compile the advertisement performance data and generate an advertisement Report. The product and service advertisement online performance results would be automatically controlled, balanced, optimized and refined to enhance advertisement online performance results by modifying one or more 4P Marketing Mix contextual smart-advertisement content keyword/multi-words at the Web-user Interface component.

The product and service marketing manager spends considerable resources developing Internet marketing and advertising concept, campaign and key components. Marketing managers is required to possess an excellent working knowledge of the broad spectrum of available Internet marketing and advertising networks and applications. Marketing managers is burdened with how to effectively integrate their product and service marketing mix/principles, concept, key components, advertising and sales into an effective online advertisement. The decision-making and determining which of the Internet advertisers (IA) Yahoo!, Google, Microsoft, etc. search engine and contextual advertising network(s) would provide most relevant web-user-search Search-Result-Page (SRP)/Web Content and site-visitor Viewer Page sponsored advertisement match functionality and computational accuracy to effectively deliver contextual advertisement.

Although, the industry has emerged with more sophisticated Internet marketing and advertising networks and systems, marketing mangers require more effective online advertisements that will promote customer Click-Through-Rate (CTR) and purchase. Marketing managers requires more involvement, flexibility, and decision-influence drivers to help in selection of Internet advertisers search engine and contextual advertising network(s) to achieve online advertising performance objectives. Marketing managers would benefit substantially by use of an automated process to support the transfer-translation of their product and service 4P marketing mix/principles, concept and key components into the Internet advertisers search engine and contextual advertising network(s). Marketing managers would benefit significantly by use of a system that has a decision-influence capability to develop and deliver a product/service 4P Marketing Mix contextual smart-advertisement to influence target customer buy-decision appropriately and effectively. Marketing managers is presented with automated and simple methods to support their budgets and expenditures that would justify their Return-On-Investment (ROI).

The iMAR system module equips marketing mangers with the capability to develop 4P marketing mix contextual smart advertisement. additionally, iMAR enables marketing mangers to use advances in computer engineering and Internet technology through an collective solutions approach that automatically selects the optimum search engine and contextual advertising network(s) to significantly improve and influence target customer buy-decision. Marketing managers need to generate effective product and service advertisements that have the most important and relevant information relating to the 4P Marketing Mix components: product/service, price, place and promotion.

The Internet (online) marketing manager and advertiser need a simple automatic process to control their product and/or service in the online/offline marketplace using available Internet technology. The Product/service marketing manager and advertiser (IA), e.g., Microsoft, Google, Yahoo, etc. does not currently use and/or have available an web-user-centered automatic computer application with decision-influence and specific functionality to develop a company's product and service advertisement containing 4P Marketing Mix (product/service, price, place, and promotion) components, with defined highly-relevant 4P Marketing Mix keyword/multi-words used specifically to determine advertisement content and are interpreted by decision-influence algorithmic routines that automatically selects the optimum Internet advertisers (IA), e.g., Microsoft, Google, Yahoo, etc Search Engine Network (Search Engine) and Contextual advertising Network with most relevant web-user-search Search-Result-Page (SRP)/Web Content and site-visitor Viewer-Page advertisement match functionality and computational accuracy to discreetly deliver 4P Marketing Mix contextual smart-advertisement. For example, the module of System 700 may provide a more targeted advertisement based on parameters. For example, keywords may be stored in an index according to different parameters where System 700 may select the index based on different 4P parameters to ensure webpage match accuracy and advertisement is located in a top banner position.

System 700 provides Internet marketing and advertising (iMAR) with decision-influence design functionality and capability to develop a product and service 4P Marketing Mix contextual smart-advertisement containing 4P Marketing Mix: (product/service, price, place, and promotion) components, with correlating defined 4P Marketing Mix keyword/multi-words correlating to each component. System 700 may be networked via Application Program Interface (API) to the Internet advertiser (Internet advertisers) Microsoft, Google, Yahoo, etc. applications, (1.) Search Engine Network (search engine) and (2.) Contextual advertising Network. In another embodiment, System 700 may interface with one or more search engines.

The Internet Marketing-advertising Reporter (iMAR) computer network application requires use of a computer server and an interface that connects to the Internet. For example, the server may access program, subroutines to execute design functionality and algorithmic computations, and Application Program Interface (API) to provide front/back-end network interface functionality with the Internet advertiser (IA) Microsoft, Google, Yahoo, etc. applications: (1.) Search Engine Network (search engine) and (2.) Contextual advertising Network.

System 700 preferably identifies iMAR System and the Internet advertiser (IA) elements. System 700 includes a system network Interface and Application Program Interface (API) with the Internet advertiser (IA), e.g., Microsoft, Google, Yahoo, etc Search Engine Network (search engine) and Contextual advertising Network.

FIG. 7 and FIG. 8 include marketing keywords/multiwords that are embedded in the product and/or service 4P Marketing Mix (product/service, price, place, and promotion) components, and are selected by marketing mangers to develop product and/or service advertisement content. Each product and/or service advertisement is interpreted by decision-influence algorithmic routines and an Application Program Interface (API) is used to automatically select the optimum Internet advertiser (IA). E.g., Microsoft, Google, Yahoo, etc. Search Engine Network. The Contextual advertising Network with the most relevant web-user-search Search-Result-Page (SRP)/Web Content and site-visitor Viewer-Page advertisement match functionality and computational accuracy is used to discreetly deliver each 4P Marketing Mix contextual smart-advertisement.

The product and service advertisement online content is generated and based on marketing mangers' choice selection of the product and service 4P Marketing Mix components (product/service, price, place, and promotion) defined 4P Marketing Mix keyword/multi-words.

iMAR applications can be network interfaced to an Internet advertiser (IA) e.g., Microsoft, Google Yahoo, etc. Search Engine Network (search engine) and Contextual advertising Network through an Application Program Interface (API) and required algorithms to promote the sharing of source code to execute a formal request for services and means of communicating and translating parameter list from one format to another and the interpretation of call-by-value and call-by-reference arguments in one or both directions. System 700 efficiently manages large volumes of accounts and campaign transactions and compiles advertisement online performance reporting data that provides statistics in a graphical and historical format with sophisticated ROI analysis. Using the analyzed data, the advertiser is able in real time to adjust the keyword ranking and to refine the keywords to better position their advertisement campaign.

The product and service 4P Marketing Mix advertisement online performance results consist of impressions, Cost-Per-Click (CPC), Pay-Per-Click (PPC), Cost-Per-Mille, Cost-Per-Mille (CPM), Click-Through-Rate (CTR), Conversions, Budget and Spending summary etc., and are measured by three primary sources (1) Internet advertiser (IA), Microsoft, Google, Yahoo, etc Search Engine Network, (2) Contextual advertising Network, and (3) iMAR 4P Marketing Mix Word/Multiword Schemas. iMAR System advertisement reports are a compilation of information representing successful application execution IAW design specification and pattern of procedures. These advertisement reports would have statistical analysis of the data and present this information in a graphical and historical format. iMAR System advertisement reports capture product and service advertisement online Performance & Reporting Results and compile highly relevant product and service 4P Marketing Mix contextual smart-advertisement performance and Return-on-Investment (ROI) reports, tailored for internal and external entities, including marketing manager, advertiser, manager, board of director, investor, media/public relations, etc.

System 700 has a reporting structure with an Internet marketing and advertising business process application, data exchange, computing, and composition solutions. Useful applications produced by System 700 provide:

1) capability and functionality to interface with existing Product/service (in-house) marketing and advertising systems;

2) capability and functionality to interface with existing Search Engine advertising servers and software systems;

3) capability and functionality to interface with existing Contextual advertising Network;

4) capability and functionality to interface with existing banner server and software systems;

5) capability and functionality to develop an online Product and service advertisement containing 4P Marketing Mix (product/service, price, place, and promotion) components;

6) capability and functionality for marketing manager and advertiser to develop Product and service advertisement by selection of one or more defined 4P Marketing Mix keyword/multi-words schemas correlating to each of the 4P Marketing Mix components: (product/service, price, place, and promotion);

7) capability and functionality for Product and service 4P Marketing Mix contextual smart-advertisement to be served and displayed independently and or linked to an existing contextual advertising network;

8) capability and functionality for Product and service 4P Marketing Mix contextual smart-advertisement 4P Marketing Mix keyword/multi-words to be interpreted by embedded decision-influence routines that algorithmically selects the optimum Internet advertiser (IA) e.g., Microsoft, Google, Yahoo, etc. (1.) Search Engine Network (search engine) with most relevant web-user-search Search-Result-Page (SRP)/Web Content sponsored advertisement match functionality, and (2.) Contextual advertising Network, e.g., Yahoo! Publisher, Google adWord, Microsoft adCenter, advertisement Reporter, etc. with most relevant site-visitor Viewer-Page sponsored advertisement match functionality and computational accuracy to discreetly deliver 4P Marketing Mix contextual smart-advertisement;

9) capability and functionality to measure and present to marketing mangers' Product and service 4P Marketing Mix contextual smart-advertisement online performance results, including impressions, Cost-Per-Click (CPC), Pay-Per-Click (PPC), Cost-Per Mille (CPM), Click-Through-Rate (CTR), Conversions, budget and spending summary, etc.);

10) advertisement quality control capability and functionally optimizes, balances and refines product and service 4P Marketing Mix contextual smart-advertisement online performance results and improve performance by modifying one or more of the 4P Marketing Mix contextual smart-advertisement keyword/multi-words content at the Web-user Interface component. The advertisement quality control allows marketing mangers to see the return on investment (ROI) and modify the keyword parameters in real time to improve results. These advertisement reports would have statistical analysis of the data and present this information in a graphical and historical format.

11) Provide capability and functionality to develop comprehensive Product and service 4P Marketing Mix contextual smart-advertisement performance with statistical/graphical/historical analysis showing Return-On-Investment (ROI) advertisement Reports, specifically tailored for internal and external entities, including marketing mangers, advertiser, manager, board of directors, investors, media/public relations, etc.

Overall, System 700 automates and significantly enhances an Internet marketing and advertising business processes and return-on-investment (ROI).

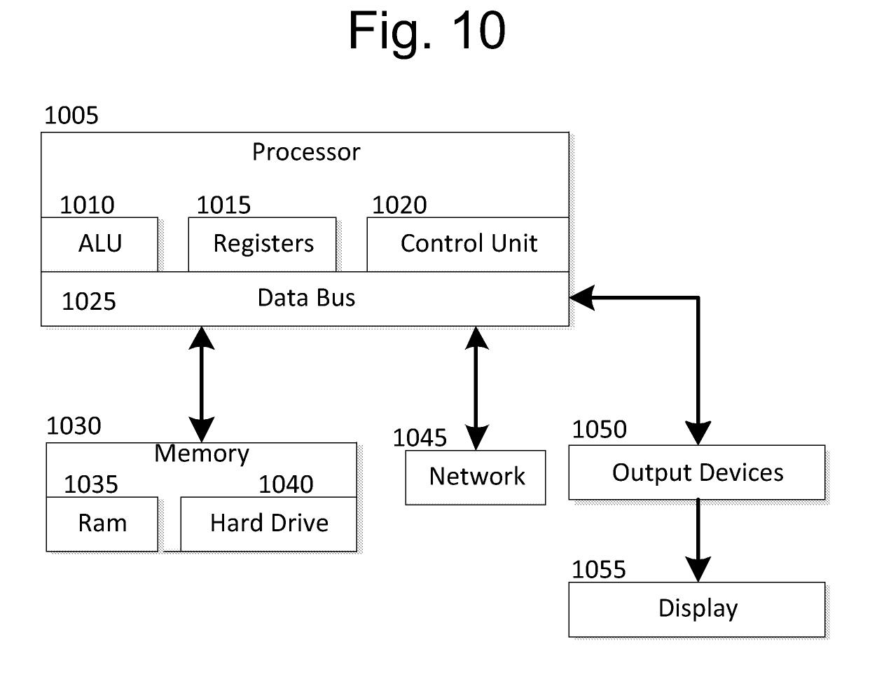

Turning now to FIG. 10, a general purpose computer 1005 can be used. It should be appreciated that system 700 is not limited to a module, or using a general purpose computer, PDA, tablet computer, smart phone or device with embedded web viewer at the home or office. The present invention may be implemented on a computer system 1005. The computer system 1005 preferably includes the generic components of most general purpose computers.

Computer system 1000 comprises an interconnection mechanism, such as a bus 1025, Arithmetic Logic Unit (ALU) 1010, Registers 1015, Control Unit 1020 or circuitry which couples to an input/output device 1050, such as a keyboard or touch screen interface. System 1000 also has a processor 1005 (such as a microprocessor having an Arithmetic Logic Unit (ALU) 1010, Registers 1015 and Control Unit 1020.) System 1000 also includes a storage device or memory 1030 (such as a computer disk 1040 for a main memory 1035 and secondary storage) and an optional output device such as a monitor or screen 1055. Generally, the bus 1055 may be connected to a network 1045 or the Internet.

Generally, in operation, the computer system operable with that method shown in FIG. 10 is controlled by an operating system. Typical examples of operating systems are Windows XP, Vista and Windows 7 from Microsoft Corporation, or Solaris and SunOS from Sun Microsystems, Inc., UNIX based operating systems, LINUX based operating systems, Android or the Apple OSX from Apple Corporation. As the computer system operates, input such as input search data, database record data, programs and commands, received from users or other processing systems, are stored on storage device. Certain commands cause the processor to retrieve and execute the stored programs. The programs executing on the processor may obtain more data from the same or a different input device, such as a network connection. The programs may also access data in a database for example, and commands and other input data may cause the processor to index, search and perform other operations on the database in relation to other input data. Data may be generated which is sent to the output device for display to the web-web-user or for transmission to another computer system or device. Typical examples of the computer system are personal computers, workstations, laptop computers, PDA's, smart phones, tablet computers, dedicated computers designed for a specific purpose, and large main frame computers suited for use many users. The present invention is not limited to being implemented on any specific type of computer system or data processing device.

Embodiments can all be implemented in hardware or circuitry which embodies the logic and processing disclosed herein, or alternatively, the present invention may be implemented in software in the form of a computer program stored on a computer readable medium such as a storage device. In the latter case, the present invention in the form of computer program logic and executable instructions is read and executed by the processor and instructs the computer system to perform the functionality disclosed as the invention herein. If the present invention is embodied as a computer program, the computer program logic is not limited to being implemented in any specific programming language. For example, commonly used programming languages such as C, C++, C#, Java, Python, and JavaScript as well as others may be used to implement the logic and functionality of the present invention. Furthermore, the subject matter of the present invention is not limited to currently existing computer processing devices or programming languages, but rather, is meant to be able to be implemented in many different types of environments in both hardware and software.

Furthermore, combinations of embodiments of the invention may be divided into specific functions and implemented on different individual computer processing devices and systems which may be interconnected to communicate and interact with each other. Dividing up the functionality of the invention between several different computers is meant to be covered within the scope of the invention.

Turning now to FIG. 11, a method 1100 begins at 1105, the entry point for the advertisement Reporter system. The search engine feeds in web-user query that contains the search string, cookie data and recent browsing history, if the web-user has been using the search engine long enough to have history. If the actual page for the search has additional relevant information this is sent along as well. If there is no search engine query string, the advertisement reporter algorithm uses just available information on the page, cookie data and recent browsing history. In the instance where no search page is present, a web bot will scan the page and recover the web page data and use this to feed the system rather than using a search string. This information is sent to the matching engine 1110, the advertisement generator 1120 and previous history database 1125. The more information that is sent to advertisement reporter the more exact the match would be to a particular 4P advertisement.

The advertisement matching engine 1110 is one of two major decision units that make up the advertisement Reporter system. The function of this step is to take all of the relevant information about the query and match it to the 4P advertisements in the database. The relevant information from 1105 includes a search string, cookie data, recent browsing history, web-user previous history and information on the present page. It can cross reference this to the web users past history. For example, if the web-web-user had recently done searches on cooking ingredients, a preference would be given to marketing advertisements that include such items.

A match is made by first settling on a topic of an advertisement. This would be a match between the search string and the product/service name. The algorithm for text matching would be a Rabin-Karp type string search algorithm or similar string matching algorithm. Different weights on the individual 4P weights would determine the best fit for the data. The weights would all be added up for every possible marketers 4P advertisement and selecting the best possible choices. It would then be further narrowed down by matching previous history, and current web page information. The database would exclude advertisements that the particular web-web-user has already seen to keep up their interest. At this point a particular marketers individual optimized 4P advertisement would be chosen and passed along to 1120.

If a Web-user has not clicked on the advertisement by a certain time (approximately 1 minute) the advertisement would time 1115 out and a new advertisement would be sent to the web-user. This would restart the process at 1110.

The advertisement generator step 1120 of the advertisement Reporter system. The matching engine has selected a specific 4P marketers advertisement to be sent to the web-user. The generator uses the search string, cookie data, the web users previous visit/search history, and information on the present page. To develop a targeted advertisement, weights would be applied to this data and the best possible targeted advertisement would be generated. The advertisement generator gets information from the advertisement matching engine 1110 the web-user previous visit/search database 1130, the incoming data 1105 and the advertisement database 1125.

Once the advertisement is served to the web-web-user, the advertisement would be either clicked on or have a time out 1125. If it is clicked on then the successful click would be recorded in the advertisement database 1135. At the same time, the W1 weights of that particular marketers 4P advertisement would be increased. The effect of increasing these weights would increase the likelihood that the advertisement be served more often as it is a successful formula. If an advertisement is not successful in a given time period, a new advertisement is generated 1115.

If the advertisement is not clicked on then another advertisement is sent to the web-web-user. The database is also informed that the particular marketers 4P advertisement was not successful and the W1 weights for that that particular advertisement would be adjusted. The adjustment would slightly reduce the weights in the order in which they were sorted by the keyword. For example the #1 promotion keyword would be reduced by 0.1% and the #10 keyword by 0.001%. This would reduce the likelihood that the advertisement would be served again. To buck the trend of constantly pulling the average down, either by random or by the advertisement Reporter staff or by automated database analysis a single keyword weight on that particular 4P advertisement would be increased by a large amount for every negative click through. The effect of this would be to shake up the weights so that the weight combination with the highest effectiveness would rise to the top. This would find the sweet spot of what web-users are looking for.

The web-user previous visit/search database 1130 contains all the previous searches and other web-user information that all visitors to the search engine web site have made. This would be used to develop a profile of the individual web-user. From this, individual preferences and purchasing patterns would emerge that help make optimal advertisement placement. This information is fed to the advertisement matching engine 1110 and the advertisement generator 1120.

The full database of all marketing mangers' 4P advertisements 1135 contains all the hits and misses for various search terms. This is the central database which all advertisement-Reporter data is taken from. It is used to serve the decision making and report generation. The database is constantly being polled by various service tasks to produce reports and generate advertisements. It directly serves 1110, 1120, 1145, 1150 and 1160. An expansion of an individual database record is in 1155.

The result of all the advertisement Reporter work is a successful click on a generated contextual advertisement 1140. The advertisement Reporter makes profits from successful click troughs and 4P marketing campaigns 1145. All of this information is in the advertisement database 1135 and must be combed through to determine billing information. This information is in the form of a report that is sent to each marketing manager to collect payment.

As marketing mangers' 4P advertising campaign progresses, marketing mangers needs to see how successful it is. The information in the advertisement database 1135 and would be combed through to see each generated advertisement, how successful each attempt was and what the search terms got an advertisement generated 1150. Marketing managers would then refine the order of the keywords and change keywords in an attempt to get better advertising success.

The expansion 1155 of each 4P record contained in the 1135 database and this shows that every 4P item has many keywords in a specific ranking. The ranking order determines which keyword is the highest priority and therefore most likely to get picked by the advertisement generator or matching engine. Marketing managers would be able to see the weights and this would tell them if they are in the right track in their ranking. For example, if one were buying tires, the keyword “shoe sale” would by natural attrition have a low weight. Marketing managers would then see that this was not a good keyword to use.

There is a service task 1160 to comb through all the weights, searches, other relevant information in the advertisement database 1155 and advertisement reporter staff input to adjust the overall weights. The advertisement report staff input helps, for example, around the holidays. Higher priority would be given to the keyword “Christmas Day Sale”.

Weights and scores can be represented in logarithmic format, for proportionally higher rewards to successful advertising campaigns. It also slowly reduces a less successful advertising campaign. This is done by having a non-linear log scale that places a high value on click through success. Click throughs are naturally not going to occur as often, the Internet is constantly bombarding users with advertisements. So a single success is important and an unsuccessful click through is only a minor failure.

From the above diagram it is obvious how the search engine is chosen for marketing mangers' advertisements. When a search string comes in, a most appropriate 4P advertisement is chosen based on keywords and weights. From marketing mangers' perpectives, their 4P chooses the most appropriate search string, albeit Microsoft, Yahoo or Google initiated search.

Turning now to FIG. 12, a method 1200 is shown. Method 1200 is similar to method 1100 except it does not generate contextual advertisements. Instead it serves up banner advertisements. Functionally these are similar but there are some key differences. These are in the Banner Matching Engine 1210, the Banner advertisement Server 1220 and the banner advertisement database 1235.

Method 1200 begins at 1205. This is the entry point for the advertisement Reporter banner system. The search engine feeds in web-user query that contains the search string, cookie data and recent browsing history, if the web-user has been using the search engine long enough to have history. Often search engines do not have banners on their search results page so general this process is used on a web-user search result page. FIG. 4 is an example of a web page that has a banner. If the actual page for the search has additional relevant information this is sent along as well. If there is no search engine query string, the advertisement reporter algorithm uses just available information on the page, cookie data and recent browsing history. In the instance where no search page is present, a web bot will scan the page and recover the web page data and use this to feed System rather than a search string. This information is sent to the matching engine 1210, the advertisement generator 1220 and previous history database 1225. The more information that is sent to advertisement reporter the more exact the match would be to a particular 4P banner advertisement.

The banner advertisement matching engine 1210 is one of two major decision units that make up the advertisement Reporter banner system. The function of this step is to take all of the relevant information about the query and match it to the 4P advertisements in the database. Note that banner advertisements are slightly different as the content of the banner is described in the Product/service section of the database and there is no generation of an advertisement. The relevant information from 1205 includes: search string, cookie data, recent browsing history, web-user previous history and information on the present page. In addition, it can cross reference this to the web users past history. For example if the web-web-user had recently done searches on cooking ingredients, preference would be given to marketing banner advertisements that included these items.

A match is made by first settling on a topic of a banner advertisement. This would be a match between the search string and the product/service name. The algorithm for text matching would be a Rabin-Karp type string search algorithm or similar string matching algorithm. Different weights on the individual 4P weights would determine the best fit for the data. The weights would all be added up for every possible marketers 4P advertisement and selecting the best possible choices. It would then be further narrowed down by matching previous history, and current web page information. The database would exclude banner advertisements that the particular web-web-user has already seen to keep up their interest. At this point a particular marketers individual optimized 4P banner advertisement would be chosen and passed along to 1220. Note that while the iMAR system would select the particular banner advertisement from 4P criteria, the actual banner likely will not contain all of the 4P information that was instrumental in selecting the particular banner.

If a Web-user has not clicked on the banner advertisement by a certain time (approximately one minute) the Banner advertisement would time 1215 out and a new advertisement would be sent to the web-user. This would restart the process at 1210.

The banner advertisement server step 1220 of the advertisement Reporter banner system.

The banner matching engine has selected a specific 4P marketers Banner advertisement to be sent to the web-user. The server either hosts the banner advertisement itself or queries a remote server at a banner host site to send the banner advertisement to the web-user. The generator uses: the search string, cookie data, the web users previous visit/search history and information on the present page. To develop a targeted advertisement, weights would be applied to this data and the best possible targeted advertisement would be generated. The advertisement generator gets information from the advertisement matching engine 1210.

Once the banner advertisement is served to the web-web-user, the banner advertisement would be either clicked on or have a time out 1225. If it is clicked on then the successful click would be recorded in the advertisement database 1235. At the same time, the W1 weights of that particular marketer's 4P banner advertisement would be increased. The effect of increasing these weights would increase the likelihood that the banner advertisement be served more often as it is a successful formula. If an advertisement is not successful in a given time period, a new banner advertisement is generated 1215.

If the banner advertisement is not clicked on, then another banner advertisement is sent to the web-web-user. The database is also informed that the particular marketers 4P advertisement was not successful and the W1 weights for that that particular advertisement would be adjusted. The adjustment would slightly reduce the weights in the order in which they were sorted by the keyword. For example the #1 promotion keyword would be reduced by 0.1% and the #10 keyword by 0.001%. This would reduce the likelihood that the advertisement would be served again. To buck the trend of constantly pulling the average down, either by random or by the advertisement Reporter staff or by automated database analysis a single keyword weight on that particular 4P advertisement would be increased by a large amount for every negative click through. The effect of this would be to shake up the weights so that the weight combination with the highest effectiveness would rise to the top. This would find the sweet spot of what web-users are looking for.

The web-user previous visit/search database 1230 contains all the previous searches and other web-user information that all visitors to the search engine web site have made. This would be used to develop a profile of the individual web-user. From this, individual preferences and purchasing patterns would emerge that help make optimal banner advertisement placement. This information is fed to the banner advertisement matching engine 1210.

The full database of all marketing mangers' banner 4P advertisements 1235 contains all the hits and misses for various search terms. This is the central database which all advertisement-Reporter data is taken from. It is used to serve the decision making and report generation. The database is constantly being polled by various service tasks to produce reports and change weights. It directly serves 1210, 1245, 1250 and 1160. An expansion of an individual banner database record is in 1255.

The result of all the advertisement Reporter work is a successful click on a banner advertisement 1240.

Advertisement Reporter gets its profits from successful click troughs and 4P marketing campaigns 1245. All of this information is in the advertisement database 1235 and must be combed through to determine billing information. This information is in the form of a report that is sent to each marketing manager to collect payment.

As marketing mangers' 4P banner advertising campaign progresses, marketing mangers needs to see how successful it is. The information in the advertisement database 1235 and would be combed through to see each banner advertisement, how successful each attempt was and what the search terms got a banner advertisement served 1250. Marketing managers would then refine the order of the keywords and change keywords in an attempt to get better advertising success.

The expansion 1255 of each 4P record contained in the 1235 database and this shows that every 4P banner has many keywords in a specific ranking. The ranking order determines which keyword is the highest priority and therefore most likely to get picked by the advertisement generator or matching engine. Marketing managers would be able to see the weights and this would tell them if they are in the right track in their ranking. For example, if one were buying tires, the keyword shoe sale would by natural attrition have a low weight. Marketing managers would then understand that this is not a good keyword to use.

The banner advertising database is slightly different from the standard 4P contextual database. The different is that the Product/service section has a segment that explains what the banner advertisement is. This would be an animated banner, a movie banner, an audio banner or a standard picture. The dimensions of the advertisement and other specifics of what the advertisement is. This would include properties like if the banner is Safe for Work in that a banner should only be displayed on appropriate web sites.

Service task 1260 combs through all the weights, searches, other relevant information in the advertisement database 1255 and advertisement reporter staff input to adjust the overall weights. The advertisement report staff input can help for example, around the holidays. Higher priority would be given to the keyword Christmas Day Sale.

Weights are represented in logarithmic format. This method gives proportionally higher reward to successful advertising campaigns. It also slowly reduces a less successful advertising campaign. This is done by having a non-linear log scale that places a high value on click through success. Click through are naturally not going to occur often as the Internet is constantly bombarding users with advertisements. So a single success is important and an unsuccessful click through is a minor failure.

While this invention has been particularly shown and described with references to a preferred embodiment thereof, it will be understood by those skilled in the art that is made therein without departing from the spirit and scope of the invention as defined by the following claims.

What is claimed is:

1. A method of contextual advertising and electronic display, comprising:
interfacing to an Internet search engine network;
search engine receiving data associated with a web-web-user of the search engine; and
parsing keywords in web-user searches on said contextual advertising system with embedded decision-influence algorithms to identify a public search-engine networks best able to respond with the most relevant advertisement results;
controlling which kind of advertisements get automatically selected by planting product/service, price, place and promotion (4P) keywords which correlate to each of the four traditional Marketing Mix categories; and
increasing matching accuracy and customer click-through-rates (CTR) and their ultimate purchase decisions with language-independent, proximity pattern matching algorithms;
wherein, an Internet Marketing-advertising Reporter (iMAR) System is provided that uses web-user data in advertisement generation and placement with the search engine.

2. The method of claim 1, further comprising:
interfacing an application that with a contextual advertising network;
receiving data associated with a 4P Marketing Mix contextual smart-advertisement on a web-user-search Search-Result-Page (SRP)/Web Content and site-visitor Viewer-Page that is generated from the product and service owner or provider of advertisements included within posted and or published websites with regard to certain additional parameters.

3. The method of claim 1, further comprising:
integrating marketing mangers' product and service marketing mix/principles, concept, key components, advertising and sales into a 4P Marketing Mix contextual smart-advertisement.

4. The method of claim 1, further comprising:
developing a 4P Marketing Mix contextual smart-advertisement, embedded with 4P Marketing Mix keyword/multi-words and language-independent proximity pattern matching algorithm to increase matching accuracy and influence advertisement Click-Through-Rate (CTR);
continuously analyzing and optimizing a selection of Internet advertiser search engine networks for which ones can best deliver relevant 4P marketing mix contextual smart advertisements;
wherein the module provides data that includes prices, geographic information, promotions, goods or services.

5. The method of claim 1, further comprising:
selecting an advertisement from those available amongst a plurality of search engines;
receiving and correlating word schemas interpreted by embedded decision-influence routines that use a continuously optimizing algorithm to select at least one search engine;
wherein the advertisement includes predetermined design features that give the advertisement a high degree of relevance to the web-user.

6. The method of claim 5, further comprising:
providing the advertisement for marketing mangers to execute the selected product or service advertisement using the information from the search engine, web page and past historical information collected on the specific web-user.

7. A method for displaying an advertisement associated with the keywords, comprising:
monitoring an Internet search engine;
selecting data related to keywords that a web-web-user has input into an Internet search engine to run a search and for displaying an advertisement associated with the keywords;
communicating the specific advertisement to the Internet search engine or other web page for display;
wherein, the specific item advertisement properties includes a product, a service, a price, a place to purchase the product/service, and a promotion; and using the information present/past information collected about the web-user and their search to select a specific advertisement.

8. The method of claim 7, further comprising:
providing a web-user-centered computer network application that provides a marketing manager with decision-influence functionality and capability to develop the data includes a product, a service, a price of an item, a place to purchase the product or service, and a promotion component;
displaying the advertisement as a standalone and or be integrated to an existing online advertisement;
displaying contextual, banner/display, or digital Internet advertisements;
wherein the data associated with the product or service and keywords are interpreted by a decision-influence algorithmic that continuously analyzes and optimizes the embedded routines to selects the best search engine; and
wherein the data further comprises multiword schemas.

9. A method for automatically generating advertisements based on 4P schema to a specific Internet search engine for electronic display, comprising:
monitoring a plurality Internet search engines;
selecting data that indicates a plurality of a search string that a web-web-user would input into the Internet search engine to run a search and for displaying an advertisement associated with the keywords;
wherein keyword data includes a product, a service, a price of an item, a place to purchase the product or service, and a promotion;
using the keyword data to select a specific advertisement; using the keyword data to select a specific Internet search engine; and
communicating a generated advertisement based on marketing mangers' 4P schema to the specific Internet search engine for display.

10. The method of claim 9, further comprising:
providing a web-user-centered computer application that provides a marketing manager with decision-influence functionality and capability to develop the data includes a product, a service, a price of an item, a place to purchase the product or service, and a promotion component;
charging a fee to develop a report of web searches, keyword success/fail rates and keyword effectiveness;
wherein the collected data associated with the product or service and keywords are interpreted by embedded decision-influence algorithmic routines that algorithmically selects the search engine;
integrating the processed relevant captured web-user data into the search engine;
connecting via a network interface with existing marketing/advertising databases and servers through their API or other interface;
developing a product or service advertisement online using components relating to product, service, price, placement, and promotion;
defining marketing mix keyword and or multiword schemas correlating to each of the product, service, price, placement and promotion;
providing keywords and multiword schemas interpreted by a decision-influence algorithmic that continuously analyzes and optimizes the embedded routines select the optimum Internet advertiser and generate the optimal advertisement that has best matches the web-user with a high degree of accuracy;
measuring online advertisement performance results and statistically reporting the results in a graphical and historical analysis;
selecting the advertisement in a continuously optimizing advertisement selection and generation system.

11. A contextual advertising system, comprising;
a set of applications to interface marketing mangers databases to obtain real time 4P product/service information;
a media bot for gathering the 4P product/service information with parameters constantly subject to changing inventory, prices, and competitive items;
wherein, data capture for an iMAR database serves up relevant advertisements to a web-user.

12. The system of claim 11, further comprising:
a mechanism for allowing marketing mangers to have direct control over 4P information through a private interface;
a mechanism for allowing marketing mangers to have direct real time access to the raw advertisement success/failure/search-string/web-user information data before statistical/graphical/historical analysis that has been accomplished;
wherein, scanned information from a media bot is used to generate 4P keywords directly to automate the process of entering in the products/services from a web site.
